(19) United States
(12) Patent Application Publication
(10) Pub. No.: US 2006/0031247 A1
(43) Pub. Date: Feb. 9, 2006

(54) System and method for the secure processing of securities transactions

(76) Inventor: Dharmesh Shah, Brookline, MA (US)

Correspondence Address: W. EDWARD RAMAGE, COMMERCE CENTER SUITE 1000, 211 COMMERCE ST, NASHVILLE, TN, 37201, US

(21) Appl. No.: 11/195,443

(22) Filed: Aug. 2, 2005

Related U.S. Application Data
(60) Provisional application No. 60/598,316, filed on Aug. 3, 2004.

(51) Int. Cl. G06F 7/00

(52) U.S. Cl. 707/102

(57) ABSTRACT

A system and method for providing for the secure and protected processing of securities transactions, particularly preventing the alteration or deletion of trades in violation of the SEC rules. A secure relational database stores, protects and verifies information regarding submitted securities transactions. As transactions are created during normal business processing, they are passed through a computer system, either using real-time or batch interfaces. All transactions stored in the vault are time-stamped, encrypted and tagged for later validation. By using sophisticated, industry-accepted methods for tagging and protecting the integrity of the data, the invention ensures the integrity of each transaction and that system rule have been enforced and applied consistently. The system can be implemented in conjunction with a variety of recordkeeping systems and proprietary platforms, including but not limited to SunGard's OmniPlus system, Relius, TrustMark WyStar and proprietary platforms.

This application claims benefit of the previously filed Provisional Patent Application No. 60/598,316, filed Aug. 3, 2004, by Dharmesh Shah, the specification and attachments of which are incorporated herein by reference, and is entitled to that filing date for priority.

### FIELD OF INVENTION

This invention relates to a system for the secure and protected processing of securities transactions.

### BACKGROUND OF INVENTION

The SEC is considering whether or not to impose a “hard” 4:00 p.m. ET cutoff by which time funds and trading systems would need to have received transactions in order for those transactions to have that day's prices applied. Details on the SEC's position can be read in the proposed rule amendments published as “Amendments to Rules Governing Pricing of Mutual Fund Shares,” Release No. IC-26288, RIN 3235-AJ01, available on the Internet at: http://www.sec.gov/rules/proposed/ic-26288.htm, and which is incorporated herein by reference.

The 4:00 p.m. cutoff represents a substantial obstacle to entities such as mutual fund and retirement plan providers who require a substantial period of time to ensure after a transaction is initiated that a transaction complies with applicable restrictions or requirements. Such entities would be at a significant disadvantage in securities markets if they were, in effect, required to initiate a transaction significantly in advance of a 4:00 p.m. cutoff in order to complete the transaction by that time. In its proposed rule amendments, the SEC specifically cites a possible alternative to the 4:00 p.m. hard cutoff which would involve a number of steps including the “electronic or physical time-stamping stamping of orders in a manner that cannot be altered or discarded once the order is entered . . . ”.

The entities described above currently use a variety of recordkeeping systems and proprietary platforms, including but not limited to SunGard's OmniPlus system. OmniPlus primarily maintains data in its VTRAN file (which is one file that is part of the OmniPlus master files). VTRAN, like the other OmniPlus files, are kept in Microfocus format on PC and Unix platforms. OmniPlus keeps a set of “audit fields” on the VTRAN record, including timestamps for activities such as transaction creation, posting, editing, and updating. In addition to each timestamp, the UserID of the user conducting the activity is also tracked. However, data kept in the VTRAN file (including all audit field information) does not seem to be encrypted in any fashion. As such, sufficiently sophisticated users could modify VTRAN data using low-level tools. Such modifications would also bypass conventional means of detection.

The primary administration interface to OmniPlus is OmniStation, a Windows (16-bit) application. Users of OmniStation generally include administrators, account manager, relationship manager, and data-entry personnel, among others. Users of OmniStation must be authenticated via OmniSecurity, a subcomponent of OmniPlus that allows definition of users, scope of access, and functional privileges.

OmniConnect is an API (application programming interface) offered by SunGard to allow development of third-party applications that interact with OmniPlus. OmniConnect is a based on DDMS (Distributed Data Management System) a proprietary messaging protocol designed and developed by SunGard EBS. A variety of applications use either DDMS directly or OmniConnect. In either case, the data being passed between the client and server is identical. Each packet that is sent via DDMS (which includes all packets sent by OmniConnect) must include authentication credentials (UserID/Password). These credentials are used to validate the user (or application) against OmniSecurity. These are the same type of credentials provided to OmniStation users. The UserID that is transmitted on the DDMS packet is in clear text. The password is encoded (not encrypted) using a proprietary SunGard algorithm.

A variety of potential vulnerabilities that exist within many OmniPlus environments. Any of these vulnerabilities could be exploited to conduct unauthorized transaction activity and avoid the intent of the SEC's hard cutoff time. For example, after the specified cutoff time, users with sufficient security could add transactions to the appropriate transaction folder using OmniStation. These transactions would be processed along with the authorized transactions. In this case, the VTRAN record would maintain audit fields regarding the user that created the transaction and the date/time the transaction was added to the system. Similarly, after the cutoff time, transactions can be deleted from the current day's transaction folder using OmniStation. Such deletions would not have a permanent audit trail and the prior audit fields (regarding transaction creation) would be lost.

Another problem exists in that various front-office systems (e.g., voice, web, etc.) may use different code to determine the trade date for a transaction. Thus, it is possible for these systems to be out-of-synch and apply business rules in an inconsistent manner. Each of these systems provides its own mechanism for specifying the cutoff time, which then controls the trade date by means of specific transaction folder naming.

Accordingly, sufficiently savvy or knowledgeable users with knowledge of low-level data structures could bypass all traditional software systems (OmniPlus, OmniStation, etc.) and directly delete or modify transactions stored within that system. Such changes would completely bypass all current audit trail mechanisms in place.

Thus, what is needed is a system that would allow retirement plan providers and similarly-situated entities to specifically address this need to secure their internal systems and preserve a secure database of transaction data to prevent altering or deleting of trades in violation of the SEC rules.

### SUMMARY OF THE INVENTION

The present invention provides for a system and method for providing for the secure and protected processing of transactions. In particular, the invention prevents altering or deleting of trades in violation of the SEC rules. An embodiment of the invention comprises a suite of software programs and components that, when implemented in concert, allow recordkeepers to address late-trading and other unauthorized transaction activity. The invention also can be implemented in conjunction with a variety of recordkeeping systems and proprietary platforms, including but not limited to SunGard's OmniPlus system, Relius, TrustMark WyStar and proprietary platforms.

The key element of the invention is a secure vault within which transactions are stored, protected and verified. As transactions are created during normal business processing, they are passed through a computer system, either using real-time or batch interfaces. All transactions stored in the vault are time-stamped, encrypted and tagged for later validation. By using sophisticated, industry-accepted methods for tagging and protecting the integrity of the data, the invention ensures the integrity of each transaction and that system rules (such as cutoff times) have been enforced and applied consistently.

By using a middleware approach, the present invention can be implemented within or in conjunction with existing recordkeeping environments. The unique approach to intercepting existing data flows allows the present invention to be implemented with no changes to the recordkeeping software or the front-end applications (e.g., voice response, web, call center, administration, etc.). This allows the core benefits of the invention to be achieved with minimal change and risk in the existing software.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### DESCRIPTION OF THE DRAWINGS

FIG. 1 is a diagram of one embodiment the subject invention in relation to client applications and a recordkeeping system.

### DETAILED DESCRIPTION OF THE INVENTION

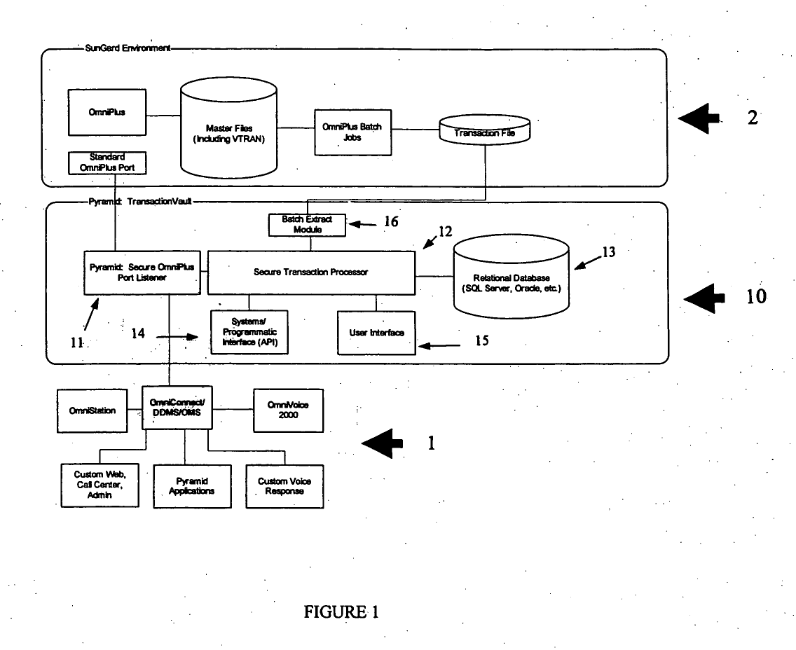

The present invention relates to a computer-based secure system for providing for the secure and protected processing of securities transactions. Referring now to the numerous figures, wherein like references identify like elements of the invention, FIG. 1 illustrates an overview of a secure system 10 utilized according to a preferred form of the invention.

The secure system 10 acts as a secure “middleware” component that resides between client applications (e.g., voice, web, call center, etc.) 1 and the recordkeeping system 2. As shown in FIG. 1, one embodiment of the invention is designed to work with a SunGard OmniPlus system as the recordkeeping system 2. Other embodiments of the invention, however, can be implemented in conjunction with a variety of other recordkeeping systems and proprietary platforms, including but not limited to Relius, TrustMark WyStar and proprietary platforms.

Input from client applications 1 is received by a secure gateway 11. In an embodiment of the invention designed to work with a SunGard OmniPlus system as the recordkeeping system 2, the secure gateway 11 is an OmniPlus port listener, which listens for OmniConnect and DDMS packets. This port listener 11 resides between all client applications 1 (e.g., OmniStation, OmniVoice 2000, Pyramid applications and OmniConnect) and processes each packet that is destined for the recordkeeping system 2 (e.g., OmniPlus).

The secure gateway 11 intercepts all transaction-related data packets (especially add/delete/update). These packets are processed and stored within the invention's relational database 13, which acts as a secure vault, either in addition to or in place of the recordkeeping system's 2 own database (e.g., OmniPlus VTRAN). Each transaction processed through by the present invention goes through specialized handling code for encryption, hashing and other forms of protection.

The secure gateway 11 also may optionally log and track every packet that is passed through the gateway 11. This logging includes detailed information about the packet, including but not limited to the UserID, Packet Name, date/time, PlanID, ParticipantID, and the like. Logging information is stored in the relational database 13, thereby allowing for sophisticated reporting and querying.

The secure gateway 11 also allows creation of low-level “rules” to prevent certain types of activity based on the user, time of day, or type of activity. For example, a rule could be defined to prevent all transaction deletions from 4:00 p.m. to 10:00 p.m.

The secure gateway 11 further can override and centralize folder determinations by client applications 1 or recordkeeping systems 2 (e.g., OmniPlus VTRAN's folder determination). Instead of each client application 1 (e.g., OmniStation, OmniVoice 2000, Pyramid, etc.) making its own determination of the trade-date (and hence the transaction folder), the packet interceptor in the secure gateway 11 could detect that a transaction is being added, and compare the current time to the cutoff time and override the folder name. This would be transparent to the client application 1.

The relational database 13 is used as a secure vault to store transactional data, the audit log, and other system information. Examples of such databases 13 include but are not limited to SQL Server, Oracle or DB2. Such databases 13 are a proven mechanism for storing and managing large volumes of information.

The secure transaction processor 12 ensures the integrity of transactional data, and employs sophisticated mechanisms to make the transactional data tamper-resistant. The secure transaction processor 12 ensures that all transactions that are created are properly logged in an encrypted form, and that the log itself is tamper-resistant. Once a transaction is created, all modifications to that transaction are securely logged. Based on non-modifiable cutoff times, transactions will be “frozen” preventing any further modifications of the transaction (including, but not limited to the trade-date, financial amounts, funds, etc.) Sophisticated tamper-resistance mechanisms will prevent low-level “hacks” of the transactional data. Any such hacks will render transactions invalid and will be logged to the system.

The secure transaction processor 12 also has the ability to prevent and detect unauthorized deletions of transactions after the cutoff time. Once a transaction has been committed to the system and the cutoff time is passed, the transaction is no longer capable of being deleted through any authorized application or system. Attempts to delete transactions using low-level data hacks (such as bypassing authorized systems) will be detected and prevented.

Interaction with the system is accomplished through a user interface 15 and an application programming interface (API) 14. In one embodiment of the present invention, the API 14 is an XML/SOAP API. The API 14 provides access to all of the critical capability that is available in the present invention, including secured algorithms. The API 14 supports functions such as creating transactions (including Omni transactions), verifying the integrity of an existing transaction that has already passed downstream, researching a transaction by retrieving the secure audit trail of all activity on that transaction (e.g., add, change, delete, commit, etc.), and determining the folder name to use for a transaction.

A secure batch transfer module 16 works with the secure transaction processor 12 to migrate a set of transaction data from the secure system to a target system (such as OmniPlus or some other trading system). The secure batch transfer module has the capability to validate the integrity of all transactions in the secure database vault (i.e., ensures that the vault had not been tampered with using unauthorized means), select the valid pool of transactions that should be migrated, verify that each transaction in the migration pool is valid and has not been altered inappropriately, store within each transaction an irreproducible “secure token” that can be used to verify that the origin of the transaction was the secure system, and transmit the batch of transactions to the target system.

The present invention implements the above components to meet the expected regulatory requirements placed on recordkeepers by the SEC, and is specifically designed from the ground-up to focus on these requirements and keeping the solution as simple and deployable as possible.

One such requirement is time synchronization, i.e., a single, trusted source for determining the current date and time. Ideally, this source resides on a single system that self-updates using an externally available time source. An embodiment of the present invention meets this need by having all critical algorithms and logic reside on a single server (i.e., the “TransactionVault” server). This server uses the industry-accepted NTP (Network Time Protocol) to periodically synchronize the system time with a trusted source. In addition, the secure system keeps an audit trail of each synchronization event within its secure database.

All trades/transactions submitted to the secure system will be time-stamped using the trusted time as established by the synchronization system. Once a transaction has been time-stamped, the transaction cannot be modified in any way (as described below). The default configuration that is shipped with each secure system is to synchronize the time once every hour. Each synchronization event is logged in the secure audit log for later verification.

By default, the cutoff time for most trades will be 4:00 ET, or earlier (as defined by regulation). This time may be adjusted for specific dates (such as holidays). To accommodate this, the secure system has a calendar that takes into account the end of business for these pre-defined days. The business calendar is kept in the secure configuration, which cannot be modified by clients or anyone else other than authorized personnel.

A centralized algorithm within the secure system software uses a combination of the current trusted time (based on synchronization) and the business calendar to determine the trade date for the transaction (i.e., the date used for pricing).

Some users of an embodiment of the subject invention may need to configure the system in specific ways (such as defining over-rides for the cutoff time). To ensure the integrity of the system, each of these configurable settings is stored in a secured (encrypted) file that is supplied by provider of the secure system. As such, clients requiring variations from the default configuration need to contact the provider. With proper approvals and documentation, the provider can supply customized configurations that are specific to an individual client. By securing the configuration, the integrity of the system is ensured so that users can not tamper with system configuration so as to circumvent the security controls and rules.

Each transaction stored in the secure system vault is assigned a globally unique ID (“GUID”) using an industry-accepted algorithm. The GUID is guaranteed to be “globally unique” (across different servers, networks or organizations). This ID can be used to uniquely identify any transaction in the secure system vault.

Each transaction stored in the secure system vault is passed through a sophisticated set of trusted algorithms for calculating a secure hash token. This hash token, which incorporates all data elements of the transaction cannot be reproduced except by the secure system itself. Any unauthorized changes to the transaction data will result in an invalidated secure token which can be easily verified. Conversely, any transaction resident in the secure system vault that has a valid secure token (i.e., one which matches the transaction data) is guaranteed to not have been modified since the secure token was generated. In this way, the integrity of each individual transaction and its constituent data can be verified.

Since the secure transaction token (“STT”) can only be generated by the system itself, any transaction that is in the secure system vault and verified is guaranteed to be valid, including all of its constituent data. This includes the User ID of the creator of the transaction. This ensures that the User ID associated with the transaction is the User ID that submitted the transaction.

Should there be a need to cancel or modify an existing transaction in the secure system vault, this action is completed as a separate and discrete event (i.e. the original transaction will never be deleted, and is simply marked as being modified or cancelled). Any such modifications or cancellations must occur prior to the designated cutoff time in order to receive the current trade date (otherwise, the new transaction gets trade-dated for the next available business day).

Each transaction creation and deletion is logged securely. The audit trail itself is tamper-resistant using the same mechanism that protects transactions stored in the vault.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A computer-based system for the secure processing of securities transactions, comprising:
a relational database containing information regarding securities transactions;
means for inputting information regarding securities transactions into the system and submission to the relational database; and
a secure processing module monitoring and controlling the flow of information regarding securities transactions contained in the relational database.

2. The system of claim 1, further comprising a secure batch transfer module adapted for the secure migration of information regarding securities transactions from the relational database to a client recordkeeping system.

3. The system of claim 1, further comprising a secure gateway module adapted for intercepting all transaction-related data packets for processing by the secure processing module.

4. The system of claim 3, wherein the secure gateway module is further adapted to log and track every transaction-related data packets.

5. The system of claim 3, wherein the secure gateway is further adapted to make determinations of the date and time of securities transactions.

6. The system of claim 1, wherein the secure transaction processor is adapted to encrypt all information about a securities transaction for storage in the relational database.

7. The system of claim 1, wherein the secure transaction processor is adapted to detect and prevent unauthorized deletions of transaction-related data after a set cutoff time.

8. The system of claim 7, wherein the set cutoff time is 4:00 p.m. Eastern time.

9. The system of claim 2, wherein the secure batch transfer module stores an irreproducible secure transaction token within each batch of transaction information to be migrated to verify the origin of that information.

10. A method for the secure processing of securities transactions, comprising the steps of:
receiving input regarding a securities transaction from client applications;
identifying transaction-related data packets;
logging and tracking all data packets;
storing all logging information in a secure database; and
storing said data packets in a secure database.

11. The method of claim 10, further comprising the steps of:
determining the trade date for the securities transaction;
determining a time stamp for the securities transaction; and
applying the trade date and time stamp to the transaction information.

12. The method of claim 10, wherein the logging information is encrypted.

13. The method of claim 11, wherein the transaction information is encrypted.

14. The method of claim 11, further comprising the steps of:
receiving a request to delete the transaction; and
preventing deletion of the transaction if the time of the request has passed an established time deadline.

15. The method of claim 10, further comprising the step of:
creating a security token relating to the logging information.

16. The method of claim 11, further comprising the step of:
creating a security token relating to the transaction information.
